(19) United States
(12) Patent Application Publication
(10) Pub. No.: US 2022/0084151 A1
(43) Pub. Date: Mar. 17, 2022

(54) SYSTEM AND METHOD FOR DETERMINING RANK

(71) Applicant: BLACKCAP PTY LTD, Sydney, NSW (AU)

(72) Inventors: Arvind Tripathi, Auckland (NZ); Shahabedin Bayati, Auckland (NZ); Danielle Mathiesen, NSW (AU)

(21) Appl. No.: 16/479,836

(22) PCT Filed: Dec. 14, 2017
(86) PCT No.: PCT/AU2017/000273

§ 371 Date: Jul. 22, 2019

(30) Foreign Application Priority Data
Jan. 23, 2017 (AU) 2017900196

(51) Int. Cl. G06Q 50/20; G06F 16/2457; G06Q 50/00; G06F 40/30; H04N 7/025; G06K 9/00

(52) U.S. Cl. CPC G06Q 50/2053; G06F 16/24578; G06Q 50/01; G06N 20/00; H04N 7/025; G06K 9/00302; G06F 40/30

(57) ABSTRACT

A method of determining rank of an institution or a student. The method of determining rank of an institution comprises receiving rank information relating to academic performance of the institution; identifying social media data associated with the institution, the social media data comprising text and video data; and analysing sentiment associated with the social media data the analysis including categorising relevance of the social media data. The method also comprises receiving endorsement data; determining strength of the endorsement data; and generating an output rank of the institution, the output rank being generated based on the rank information, the determined relevance of the social media, and the determined strength of the endorsement data.

### RELATED APPLICATION(S)

This application claims Convention priority from Australian Provisional Patent Application No. 2017900196, the contents of which are incorporated by reference in their entirety.

### TECHNICAL FIELD

The present invention relates generally to a system and method for determining a rank of an education institution or student. The present invention also relates to a computer program product including a computer readable medium having recorded thereon a computer program for determining a rank of an institution or student.

### BACKGROUND

Students seek access to education institutions such as universities, colleges and the like across the world to find the most suitable place to study. Rankings provide important guidance to students in selecting a suitable education institute. Some known ranking publications such as Times Higher Education, QS World University Rankings™ and Webometrics provide ranking information to students. However, most known ranking publications use metrics based on academic performance of the staff of an institution, and fixed statistics such as student to faculty ratio and the like. Many other factors important to students include social activities available, institution relationship with top industries, alumni reputation and social capital, leadership and social engagement. Differences across the global tertiary education systems are typically unaccounted for in ranking institutions. For example, academic seasonality across different geographies, over-representation of top-ranked universities and measuring perceptions of alumni employability rather than actual employment outcomes and other factors can vary across global populations of universities and students.

Other factors (for example, social activities available, social capital, leadership and social engagement) are not considered in the ranking of an education institution but are typically important to potential students. While social media can provide some indication of the factors that are not typically considered, social media typically comprises dynamic, complex and unstructured data. Given the large amounts of data and frequent unknown identities associated with social media, determining accurate and relevant information for generating a rank is difficult. Some of the factors described above have been identified in academic literature as relating to education ranking. However, there is no comprehensive and integrative approach to quantifying and using social media data to generate a meaningful ranking.

On the other side, education institutions such as universities receive a large number of applications from students for admission every year. Each institution has a process for selecting and permitting admission to students. Admission data generally relates to academic data. While many students use social media, it is also difficult for universities to verify and sort social media data to identify suitable students based on factors other than academic performance.

### SUMMARY

It is an object of the present invention to substantially overcome, or at least ameliorate, one or more disadvantages of existing arrangements.

One aspect of the present disclosure provides a method of determining rank of an institution, comprising: receiving rank information relating to academic performance of the institution; identifying social media data associated with the institution, the social media data comprising text and video data; analysing sentiment associated with the social media data, the analysis including categorising relevance of the social media data; receiving endorsement data; determining strength of the endorsement data; and generating an output rank of the institution, the output rank being generated based on the rank information, the determined relevance of the social media, and the determined strength of the endorsement data.

Another aspect of the present disclosure provides a method of determining rank of a student, comprising: receiving information relating to academic performance of the student; identifying social media data associated with the student, the social media data comprising text and video data; analysing sentiment associated with the social media data, the analysis including categorising relevance of the social media data; receiving endorsement data; determining strength of the endorsement data; and generating an output rank of the student, the output rank being generated based on the academic performance of the student, the determined relevance of the social media, and the determined strength of the endorsement data.

Another aspect of the present disclosure provides a non-transitory computer readable storage medium having a computer program stored thereon for determining rank of an institution, the computer program comprising: code for receiving rank information relating to academic performance of the institution; code for identifying social media data associated with the institution, the social media data comprising text and video data; code for analysing sentiment associated with the social media data, the analysis including categorising relevance of the social media data; code for receiving endorsement data; code for determining strength of the endorsement data; and code for generating an output rank of the institution, the output rank being generated based on the rank information, the determined relevance of the social media, and the determined strength of the endorsement data.

Another aspect of the present disclosure provides a non-transitory computer readable storage medium having a computer program stored thereon for determining rank of a student, the computer program comprising: code for receiving information relating to academic performance of the student; code for identifying social media data associated with the student, the social media data comprising text and video data; code for analysing sentiment associated with the social media data, the analysis including categorising relevance of the social media data; code for receiving endorsement data; code for determining strength of the endorsement data; and code for generating an output rank of the student, the output rank being generated based on the academic performance of the student, the determined relevance of the social media, and the determined strength of the endorsement data.

Another aspect of the present disclosure provides a system, comprising: a memory for storing data and a computer readable medium; and a processor coupled to the memory for executing a computer program, the program having instructions for: receiving rank information relating to academic performance of an institution; identifying social media data associated with the institution, the social media data comprising text and video data; analysing sentiment associated with the social media data, the analysis including categorising relevance of the social media data; receiving endorsement data; determining strength of the endorsement data; and generating an output rank of the institution, the output rank being generated based on the rank information, the determined relevance of the social media, and the determined strength of the endorsement data.

Another aspect of the resent disclosure provides a system, comprising: a memory for storing data and a computer readable medium; and a processor coupled to the memory for executing a computer program, the program having instructions for: receiving information relating to academic performance of a student; identifying social media data associated with the student, the social media data comprising text and video data; analysing sentiment associated with the social media data, the analysis including categorising relevance of the social media data; receiving endorsement data; determining strength of the endorsement data; and generating an output rank of the student, the output rank being generated based on the academic performance of the student, the determined relevance of the social media, and the determined strength of the endorsement data.

Other aspects are also disclosed.

### BRIEF DESCRIPTION OF THE DRAWINGS

At least one embodiment of the present invention will now be described with reference to the drawings and appendices, in which:

FIGS. 1A and 1B collectively form a schematic block diagram representation of an electronic device upon which described arrangements can be practised;

FIG. 2 is a schematic flow diagram of a method for determining a rank of an education institution according to one aspect of the present disclosure;

FIG. 3 shows a software architecture for determining a rank of an education institution or student;

FIG. 4 shows a data flow used in FIG. 2 and FIG. 6;

FIG. 5 shows a data flow used in FIG. 2;

FIG. 6 is a schematic flow diagram of a method for determining a rank of a student according to one aspect of the present disclosure;

FIG. 7 shows a dataflow used in FIG. 6;

FIG. 8 shows an example structure of factors used in determining a rank of an institution; and

FIG. 9 shows an example structure of factors used in determining a rank of a student.

### DETAILED DESCRIPTION INCLUDING BEST MODE

### Overview

It is to be noted that the discussions contained in the “Background” section and that above relating to prior art arrangements relate to discussions of documents or devices which form public knowledge through their respective publication and/or use. Such should not be interpreted as a representation by the present inventor(s) or the patent applicant that such documents or devices in any way form part of the common general knowledge in the art.

Where reference is made in any one or more of the accompanying drawings to steps and/or features, which have the same reference numerals, those steps and/or features have for the purposes of this description the same function(s) or operation(s), unless the contrary intention appears.

As described above, traditional ranking of education institutions, referred to as institutions for brevity, generally relates to numerical data, also referred to as numerical information, such as academic reputation, faculty citations, student to faculty ratio, international outlook and student diversity. Much of the information is static and is updated on yearly basis. Appendix 2 shows a list of factors typically considered in traditional ranking methods. The ranking data is not determined in real-time, and does not reflect ongoing changes at a given institution. For example, educational institutions in the northern and southern hemispheres have different start and end dates for academic semesters. Accordingly, reporting on a calendar year basis only is not an accurate basis of comparison.

Many other factors that will affect suitability of an institution for a potential student and quality of life for the student in attending the institution are not considered in providing a ranking. Examples of the factors that are not considered include social activities available, social capital, leadership and social engagement. Factors such as institution relationship with relevant industries and alumni reputation are not typically considered in a consistent manner across the global tertiary education system and thus rankings are not usually representative of the majority of relevant factors. In one example, QS World University Rankings™ find that international students returning home after finishing their degree might be effected by poor local economic conditions and therefore focus on perceived employability rather than actual employment. However, some students overcome employment adversity by selecting a more employment-rich area or country to migrate too after graduating. A success rate of students who choose employment-rich countries in gaining employment is also reflective of the quality of the university attended and the degree completed. Accordingly, measuring actual employment outcomes can remove inaccurate perceptions of employability in determining rank of a university.

Additionally, factors such as social capital and alumni reputation play a critical role in students' decision making when selecting and ranking institutions. Information relating to relevant factors can typically be found in social media. However, due to the remote nature and large amounts of data of social media, quantifying the nature, accuracy and relevance of social media has traditionally been unreliable, and factors derived from unstructured data excluded from ranking systems.

There is currently no service available to integrate dynamic, complex and unstructured data of these factors and determining or updating a rank in real time. There is no method to collect and prioritize endorsements from peers, competitors, experts and a trusted social network for combination with qualitative and quantitative data from university websites and external ranking organisations like QS World University Rankings™. There is no ranking system available that creates spontaneous virtual recorded endorsements that humans perceive as authentic and are included as part of a university ranking methodology.

The arrangements described quantify social media data, for example sentiments using text, image and video data as a part of education institution ranking methodologies. The arrangements described provide a means of categorising the impact of written and video endorsements by evaluating the authenticity of the data as part of an institution ranking methodology.

In the context of the present disclosure, “authentic” or “authentic data” relates to data that is determined to represent a person's actual beliefs and that is perceived to be natural and honest based on facial expressions. Authenticity of data is measured to determine rank of a student or institution, as described hereafter.

Similar problems exist for education institutions endeavouring to select potential students. Student academic records and their transcripts are the major source of ranking students for admissions. Each institution typically performs the student ranking in a different own way. Much of the student record data is static and is updated on yearly basis. There is no service that determines students ranking scores in real-time to reflect ongoing changes.

Social capital and alumni data play a critical role in an institution's decision making when selecting and ranking students. There has been no method to integrate dynamic, complex and unstructured data and determine a single score in real time. Information relating to student traits or factors such as endorsements, education background and leadership skills may be present in social media but are similarly difficult to quantifying in terms of accuracy and relevance.

The arrangements described relate to quantifying sentiments relating to students using text, image and video data as a part of student ranking methodologies. The arrangements described prioritise the impact of social media data, including written and video endorsements by evaluating authenticity of the data as part of a student ranking methodology. The arrangements described relate to a system and method that creates spontaneous virtual recorded endorsements that humans perceive as authentic and are included as part of a student ranking methodology.

The present disclosure relates to a ranking platform based upon traditional ranking data and data derived from social media and endorsements. The arrangements described allow for real-time updates to ranking (both of institutions and students) based upon latest social media data and endorsements. The systems and methods described relate to a general social media platform for students to collaborate in content generation across the students' interests and preferences about desired universities. The platform gives institutions an opportunity to analyse a student's performance. The platform is based on salient features such as students' endorsements, education background, and leadership skills to provide an adaptive ranking mechanism.

The arrangements described are typically implemented on a computer such as a server computer. The server computer is in communication with at least one of an institution device and a student device.

### Computer Description

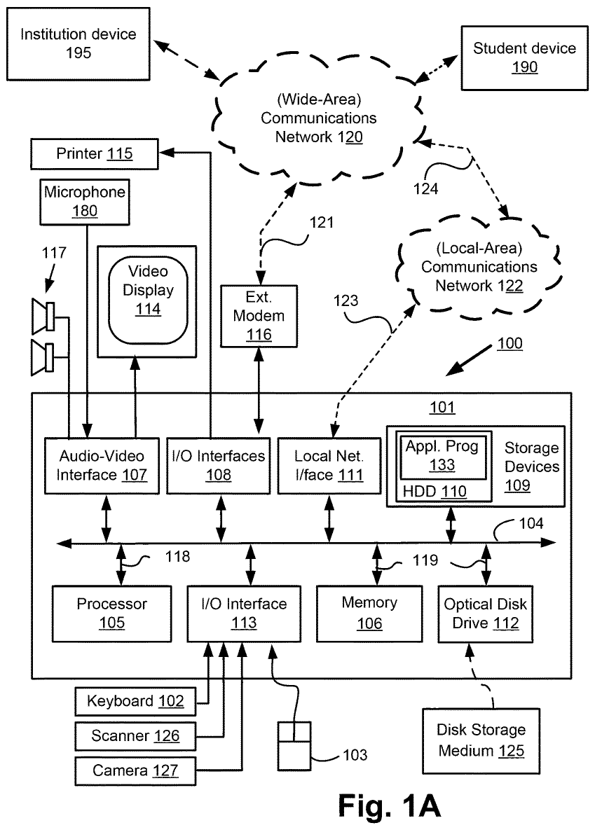

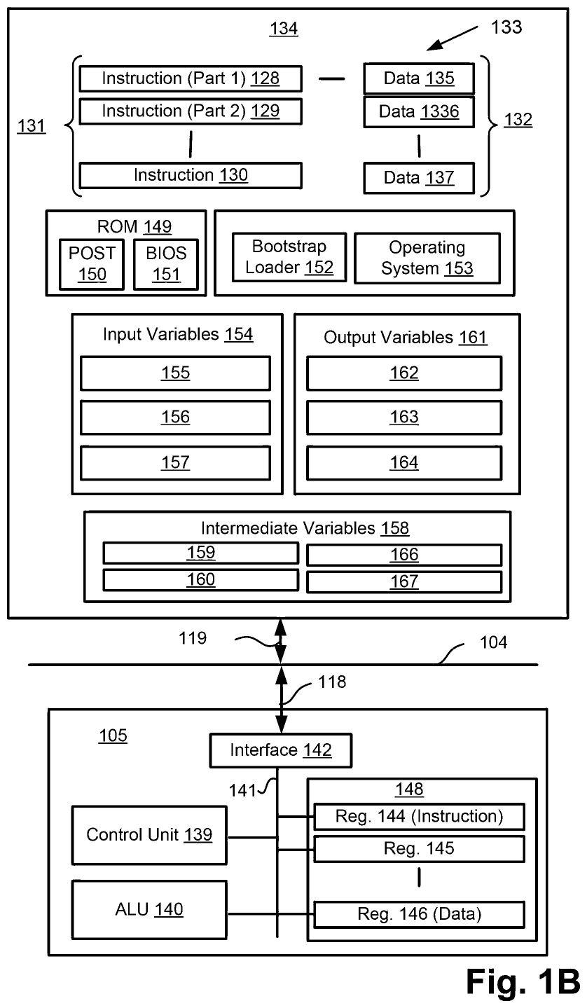

FIGS. 1A and 1B depict a general-purpose computer system 100, upon which the various arrangements described can be practiced.

As seen in FIG. 1A, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

In the arrangements described the computer module 101 is typically a server computer, such as a cloud server computer. In other arrangements, the computer module 101 may be a different type of computing device, for example a user device, such as a desktop computer or a laptop computer.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth wireless arrangement or an IEEE 802.11 wireless arrangement; however, numerous other types of interfaces may be practiced for the interface 111.

The server computer 101 is typically in communication with at least one of an institution device 195 and a student device 190. Each of the student device 190 and the institution device 195 operate in a similar manner to the server computer 101. The devices 190 and 195 can is some arrangements be endorser devices, that is used by persons providing endorsement data for an institution or student.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

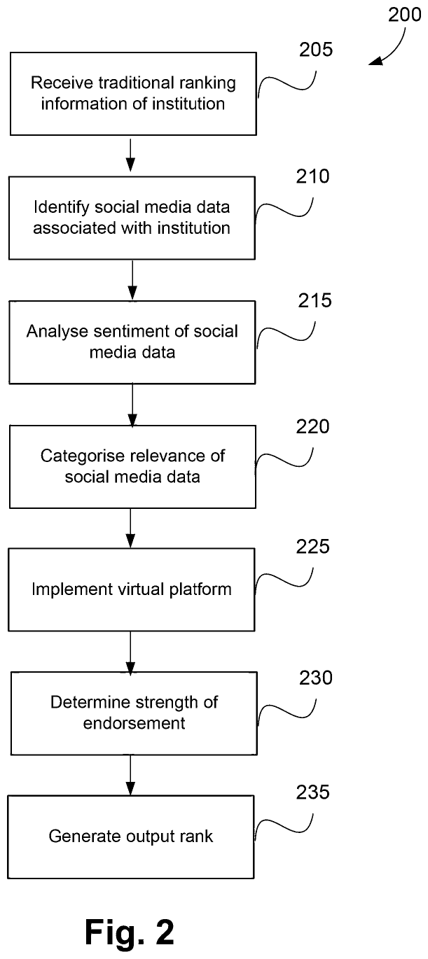

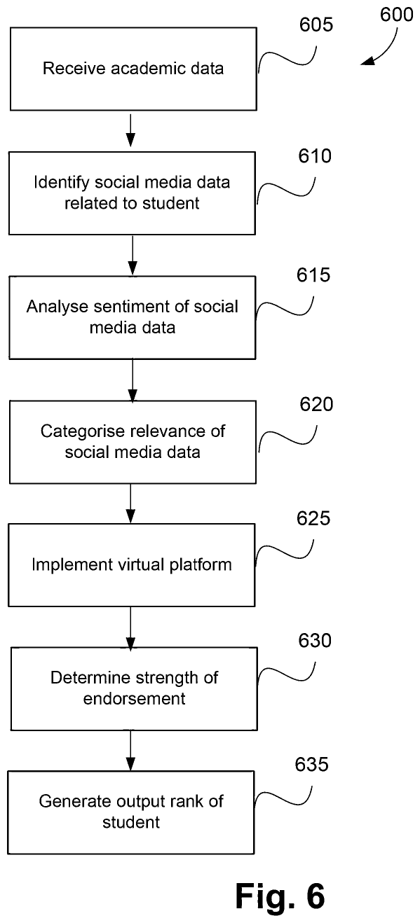

The methods of determining a rank of an institution or student may be implemented using the computer system 100 wherein the processes of FIGS. 2 and 6, to be described, may be implemented as one or more software application programs 133 executable within the computer system 100. In particular, the steps of the methods described are effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for determining a rank of an institution or student.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for determining a rank of an institution or student.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The described arrangements use input variables 154, which are stored in the memory 134 in corresponding memory locations 155, 156, 157. The described arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:
a fetch operation, which fetches or reads an instruction 131 from a memory location 128, 129, 130;
a decode operation in which the control unit 139 determines which instruction has been fetched; and
an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 2 and 6 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The methods of determining a rank of an institution or student may alternatively be implemented in dedicated hardware such as one or more integrated circuits performing the functions or sub functions of the methods. Such dedicated hardware may include graphic processors, digital signal processors, or one or more microprocessors and associated memories.

### Ranking Education Institutions

The present disclosure relates to a method that uses academic, social and alumni data to determine a single score or ranking in real time. The arrangements described provide efficiency in evaluating multiple institutions and ranking the institutions on a single metric, so that a human's decision making criteria for selecting an institution (e.g. a university) is improved.

FIG. 2 shows a method 200 of ranking education institutions. The method 200 is typically implemented as one or more modules of the application 133, stored in the hard drive 110 and executed under control of the processor 105. The method 200 relates to using text and video endorsements from peers, competitors, experts and social network by recording, determining quantitative scores. The method 200 combines the scores with existing data sources such as QS World University Rankings™ and unstructured social media data to provide a comprehensive model for ranking institutions.

The method 200 starts at a receiving step 205. The server computer 101 operates to receive traditional, structured ranking information at step 205. The traditional ranking information is typically in numeric form and relates to academic reputation, faculty citations, student to faculty ratio, international outlook and student diversity. The ranking information is received from the institution computer 195, or from third party computer devices (not shown) such as ranking websites, for example QS World University Rankings™, Google Scholar™, Times Higher Education College Rankings and The Complete University Guide. The ranking information can be received using mechanisms such as licensing ranking data, transmitting data requests, and the like. Data inputs can be used pursuant to a data licensing or data sharing agreement or arrangement.

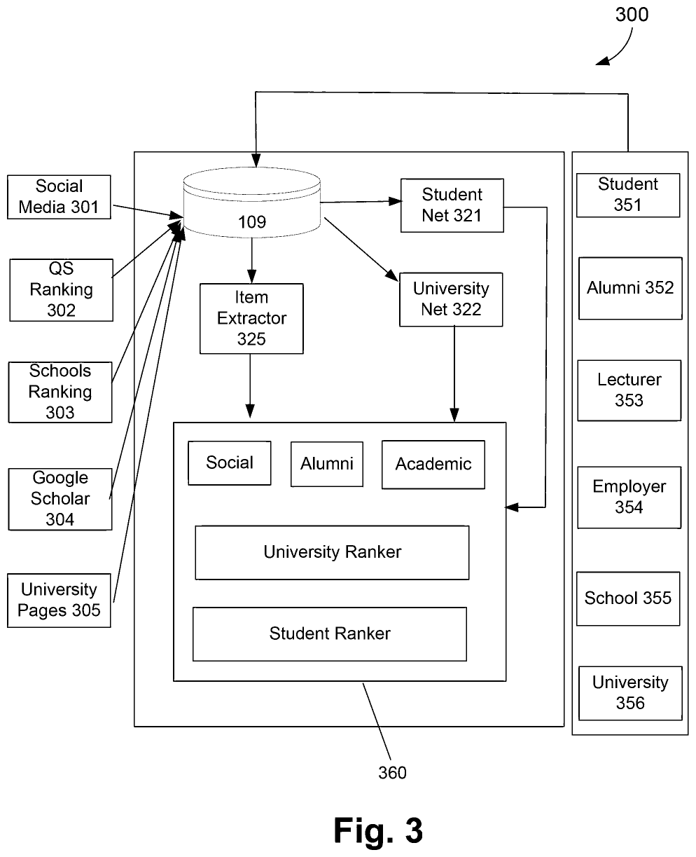

FIG. 3 shows a software architecture 300 used in the method 200. The method 200 receives data from both external and internal inputs. External inputs relate to external social media sources, such as external social media websites and applications (e.g., Facebook or Twitter and the like). External inputs can also relate to other types of websites, for example traditional ranking websites. External inputs can relate to text, video or other types of data.

Internal inputs relate to data received via a virtual platform operated by the computing device 101 (as described in relation to step 225 below). Internal inputs received from the virtual platform can relate to text or video input or the like. Video inputs, whether internal or external inputs, can relate to spontaneous video (recorded live and received in near real-time) or non-spontaneous video (previously recorded). For ease of reference, inputs 301 to 305 of FIG. 3 represent both internal and external inputs.

The responses are received and stored in the memory 109, for example in a temporary portion of the memory 109. The step 205 executes to receive structured data, such as data from inputs 302 to 304. The step 205 can also receive semi-structured data such as university pages in HTML and W3C formats.

The method 200 progresses from the step 205 to an identifying step 210. At the step 210, the method 200 identifies unstructured data, typically social media data, relevant to the institution. The social media data includes but is not limited to text and video data. The social media data can relate to both internal and external input data identified through the input 301 from a social media database associated with the institution. For example, the social media data can be derived from external social media accounts associated with the institution (such as Facebook accounts) or social media data obtained from a virtual platform operated by the server computer 101. Social media data can be obtained using relevant known social media searching methods such as using hashtags and the like. The searching methods used to source appropriate social media data depend on the data source and the purpose of the search. Searching on external social media data bases can for example use known application programme interfaces (APIs) for social media platforms such as Facebook (Graph API), Twitter (REST API) and the like. The internal social media database is typically associated with a social media platform provided by the computing device 101, for example a virtual platform implemented at a step 225, as described hereafter. The social media data, whether internal or external, is identified using known social media techniques such as word searching, recognising hashtags, and the like. An item extractor 325 executes to identify relevant data social media data from external elements of the inputs 301 to 305.

The method 200 progresses from step 210 to an analysing step 215. At step 215, the application 133 executes to analyse a level of positive or negative sentiment present in written and video social endorsements. Sentiment analysis is conducted using known techniques such as using trained classifiers to detect sentiment in video data. In an example approach, text is categorized as positive, negative or neutral based on a number of positive or negative words used in the text. The number of words can be compared to a threshold. The threshold can be dynamically determined or be a predetermined threshold based on experimental results. Analysis of video data can relate to categorising different expressions or emotions, for example neutral, happy, surprise, anger, disgust, fear, sadness and the like. See N. Sebe et al., Authentic facial expression analysis, Image Vis. Comput. (2006),doi:10.1016/j.imavis.2005.12.021, for example.

In some arrangements, a positive sentiment finding increases rank and a negative sentiment finding decreases rank. In other arrangements, a positive sentiment finding decreases rank and a negative sentiment finding increases rank.

The method 200 progresses from step 215 to a categorisation step 220. At step 220, the impact or relevance of the social media data is categorised. The impact of the identified social media is categorised in terms of recency, consistency, expertise, trust and other factors relating to the relationship between an endorser and an endorsee (person posting the social media and subject of the social media). The social media can be categorised as being recent/not recent, or consistent/not consistent for example.

The method 200 progresses from the step 220 to an implementing step 225. At step 225, the method 200 implements a virtual platform. The virtual platform randomly generates questions and presents the questions to an endorser of the institution, for example transmitting the questions as video data to an endorser device. An example of an endorser of an institution is a student or alumni of the institution. For example, the questions are transmitted to the institution device 195 (or another device) for display to a user. The user provides spontaneous video responses to the randomly generated questions. The user responses are transmitted to the server computer 101. The responses received are considered genuine compared to responses to questions which endorsers have had time to rehearse. The method 200 accordingly inherently provides a degree of confidence in the endorsements received. The virtual platform is represented by an application 322, labelled “University Net” in FIG. 3. The application 322 also operates to receive traditional social media data structures linked to user accounts. For example, the virtual platform can receive text inputs such as posts, and other type of inputs such as image, audio and video files posted by users, and display the received information to appropriate user accounts.

The virtual platform implemented at step 225 is configured to verify a real person gives the endorsement in a spontaneous manner. Authentication that the endorser is a real person is preferably implemented by the application 133 prompting the endorser to provide an image of themselves captured at the time of endorsement, for example using a camera of a smartphone. In alternative implementations, the endorser can provide 2 factor authentication of identity using known mechanisms such as email or SMS. Additionally, any user of the platform implemented at step 225 is typically required to complete a standard “not a robot” test, for example using CAPCHA code techniques.

The method 200 proceeds from the step 225 to a determining step 230. Step 230 effectively operates to determine whether the person provides a spontaneous or non-rehearsed endorsement. The application 133 determines a strength of each endorsement received at step 225. The virtual platform of step 225 executes to identify and analyse facial expressions of the endorser. In particular, the virtual platform executes to compare video responses received with a database of authentic facial expressions or using industry standard software packages such as Microsoft™ Cognitive Services to determine the strength of the endorsement for use in determining the rank of the institution. The virtual platform also uses the verification that the endorser is a real person (for example by providing an image or using 2 factor methods discussed above) to determine the strength of the endorsement. If the endorser does not verify that they are a real person, the strength of the endorsement will normally be decreased compared to an endorser who does provide verification. Appendix 1 represents pseudo-code for an endorsement algorithm.

The strength of the endorsement relates to the determined authenticity of the endorsement. The stronger (more authentic) an endorsement value is determined to be, the higher the impact of the endorsement on rank of the university. The impact can be implemented as a continuous or discrete function. In a discrete implementation, if a response is determined to relate to a positive expression (such as joy or surprise), the impact is positive on the rank. Conversely, if a response is determined to relate to a negative expression (such as fear or anger), the impact is negative on the rank. In a continuous example, some identified expressions or emotions are afforded greater impact on rank than others—for example surprise may have a greater impact than expressions determined to be joy or neutral. In some arrangements, the strength is compared to a threshold to determine whether to use the strength in determining rank. The threshold can be dynamically determined or a predetermined threshold. The threshold, or a dynamic expression representing the threshold, can be determined by experimentation for example.

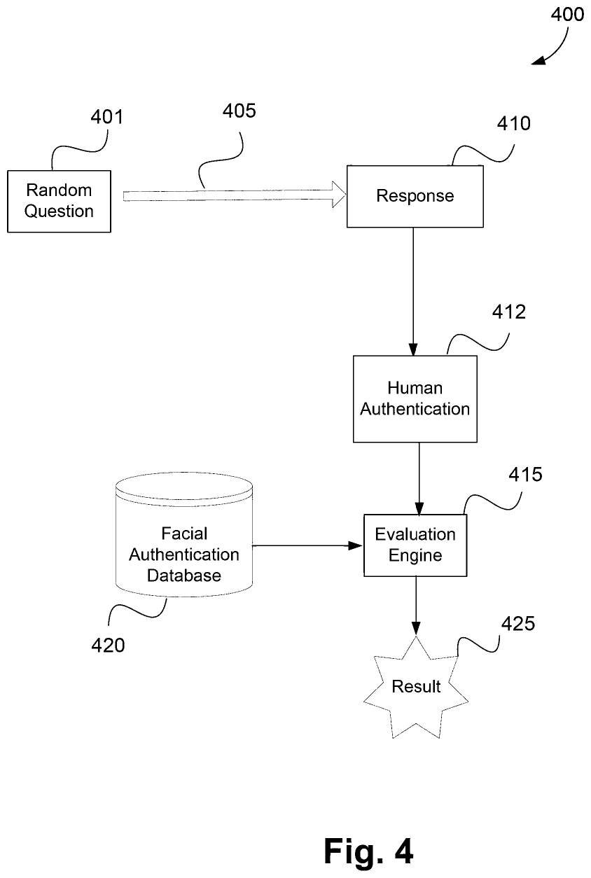

FIG. 4 shows a data flow 400 used at the steps 225 and 230. The data flow 400 starts with selection of a question randomly from a database 401 of questions. The database is typically stored in the hard drive 110. The question is transmitted to the device 190 as indicated by an arrow 405. The question may be transmitted as a text or video transmission for reproduction on the device 190. Transmitting the question relates to implementing the virtual platform at step 225. The application 133 receives a response 410 from the student device 190. The response is video data of the endorser providing an endorsement. The application 133 in some implementations receives a human authentication 412 to verify that the endorser is a real person. The human authentication can be a captured image or relate to 2 factor authentication techniques, as described above. The human authentication can relate to a “not a robot” test instead of, or in addition to, the captured image and 2 factor techniques.

The response and the human authentication are transmitted to an evaluation engine 415. The evaluation engine is a module of the application 133. The evaluation engine executes to identify facial expressions in the video data. The facial expressions are identified using known industry techniques such as machine learning or available software packages such as Microsoft™ Cognitive Services. The evaluation engine may analyse the facial expressions by accessing a facial authentication database 420 and compares the identified facial expressions to expressions stored in the database 420. If the identified facial expressions match one of the stored authentic expressions, the endorsement is determined to have a relatively high strength. If the identified facial expressions do not match one or more stored authentic expressions, the endorsement is determined to have a relatively low strength. Matching and analysis of the facial expression is implemented using known image recognition techniques such as machine learning methods (for example, algorithms for emotion detection which include techniques such as Bayesian networks, support vector machines (SVM) and decision trees). Accordingly, the step 230 provides a means of determining whether endorsements are trustworthy, as reflected in the determined strength. The output of the application 133 is provided to a ranking engine 360, as shown in FIG. 3. The step 230 outputs a strength result, as indicated by a result 425 in FIG. 4.

Where a video image is not available or the user is not willing to share a video, then an alternative method can be used to ensure a user is a genuine human user, such as 2-factor authentication via a confirmation email or SMS in order for an endorsement to be posted. In implementations where the human authentication 412 relates to a captured image or 2 factor authentication, the authentication 412 can be received before or after the evaluation engine determines the result. If the human authentication is received after the evaluation engine 215 determined the result 425, the result 425 is updated.

The method 200 progresses under execution of the processor 105 from step 230 to a generating step 235. The step 235 executes to generate an output rank. The output rank is generated based on the rank information of step 205, the determined relevance and categorisation of the social media (steps 215 and 220), and the determined strength of the endorsement data (step 230). Referring to FIG. 3, the ranking engine 360 generates the rank of the institution.

The steps of the method 200 are implemented in an exemplary order in FIG. 2. In other arrangements, some of the steps of the method 200 may be executed concurrently. The method 200 operates to update in real-time when a new endorsement is received, or new social media data is received. If a certain type of data is not received, for example data from social media, the method 200 can execute nonetheless.

In one arrangement, the step 235 executes to determine ranking of an institution, such as a university, based on Equation (1) below:

UniRankingᵢ=f(Acadmicᵢ,Socialᵢ, Alumniᵢ) (1)

The subject of the ranking is an institution, such as a university (Uni). University is an organization, which is evaluated based on academic performance of employees.

The function of Equation (1) is typically implemented in a linear format of an AHP (Analytical Hierarchy Process) model for ranking based on weights. AHP is a multi-criteria decision-making technique. Weights are assigned using an analytical hierarchy process according to importance of factors of the function of Equation (1). Summation of the weights should total 1. Metrics, also referred to as factors (Social, Academic, and Alumni), used in Equation (1) are evaluated through sub-metrics and from different resources described above, for example QS rating data and social media data. The metrics are converted into numerical and normalized values with similar scales.

UniRankingₓ=W₁Academicₓ+W₂Socialₓ+W₃Alumniₓ[WhereΣWᵢ=1] (2)

The Academic factor is typically broken down into a new weighted list of sub-factors. In order to evaluate academics, publications and citations of the academics are required, as indicated by Equations (3) and (4). Data relating to publications and citations is usually determined from publication databases such as the ERA 2015 Submitted Journal List by the Australian Research Council, Better Education Uni Rankings, University satisfaction rankings produced by the governments and the like.

Academicₓ=W₁₁Publicationₓ+W₁₂Citationₓ+W₁₃SocialNetFeedbackₓ+W₁₄StandardUniveristyRankiingₓ+W₁₅EndorseValueₓ+W₁₆AcademicFacilitiesₓ[Where ΣW₁ᵢ=1] (3)

Academic=F₁(Publication,Citation, SocialNetFeedback, StandardUniversityRanking, EndorseValue, AcademicFacilities) (4)

Similarly, the Social and Alumni factors are each broken down into a new weighted list of sub-factors. Equations (5) and (6) below relate to the social factor, and Equations (7) and (8) to the Alumni factor. Data for the Alumni factors can be derived from statistics published by the institution relating to alumni, external social media sites (such as LinkedIn), or from data provided by alumni to the virtual platform of step 225. Data relevant to the Social factor and Alumni factor will be typically derived from the virtual platform of step 225.

Socialₓ=W₂₁SocialNetFeedbackₓ+W₂₂EndorseValueₓ+W₂₃ActiveTimeₓ[WhereΣW₂₁=1] (5)

Social=F3(SocialNetFeedback, Endorse Value, Active Time) (6)

Alumniₓ=W₃₁SocialNetFeedbackₓ+W₃₂SalaryRangeₓ+W₃₃TimeToJobₓ+W₃₄EndorseValueₓ[WhereΣW₃ᵢ=1] (7)

Alumni=F4(SocialNetFeedback, SalaryRange, Time To Job) (8)

The factors described above provide a general model for ranking institutions. The arrangement using Equations (1) to (8) is relatively flexible and can be manipulated in terms structure and weight values without undue difficulty.

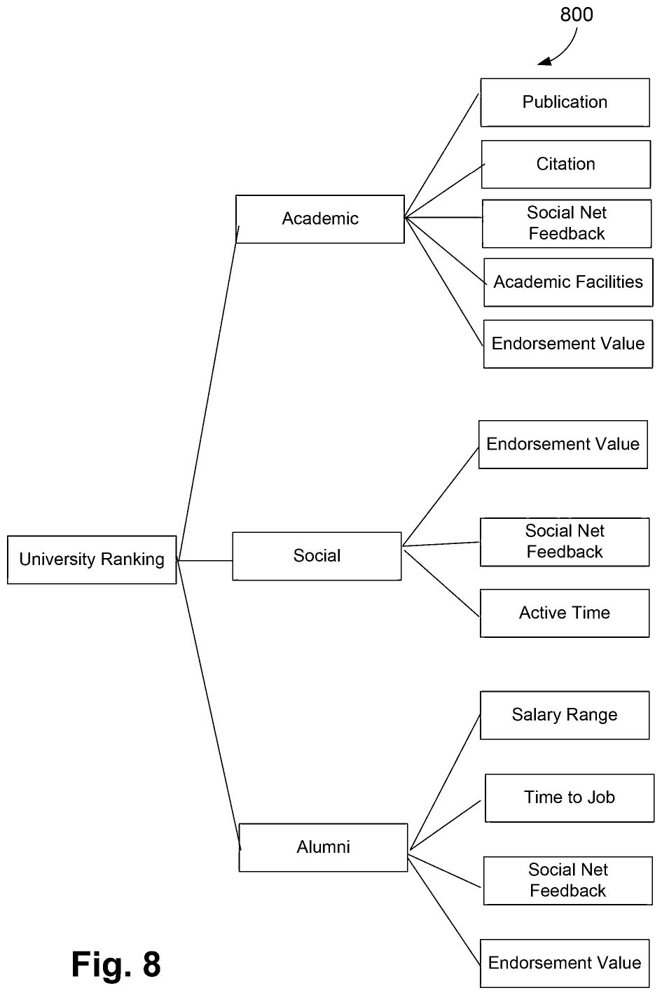

FIG. 8 shows an example of a tree structure 800 of factors and associated sub-factors considered in determining rank of an institution.

Another arrangement relates to further determination in relation to more “blurred” factors, being factors more difficult to quantitatively define, for example unstructured social media data and endorsements received at steps 225 and 230. The arrangement relating to the blurred elements has less flexibility compared to the arrangements described in relation to Equations (1) to (8) but can provide a more refined result.

The second arrangement considers the social network endorsement by other students. The other students can be current or past attendees of the institution for example. The generated ranking accounts for an effect of recency of endorsement, reputation of the endorser, and trust or strength determined for the endorsement. An initial endorsement value is determined according to Equation (9).

EndorseValue(i,j,Iₓ)=W_{ic}×EndorseRatingᵢⱼ×Wₘ×Successful(i)×Consistant(j,Iₓ)×Trust(i) [Where j∈c] (9)

Equation (9) determines the strength value of one endorsement sent by user i (student/teacher) to student j. c represents the Community that j belongs to, such as a school. A rating is determined according to Equation (10) below.

$${EndorseRating}_{ij} = \frac{\frac{\vert {ReceivedEndorse}_{i} \vert}{\vert {SentEndorse}_{i} \vert}}{CurrentPeriod - EndorsementPeriod} \qquad ( 10 )$$

In Equation (10), ReceiveEndorse, relates to the institution which received the endorsement, SentEndorse, relates to an entity that provided the endorsement. CurrentPeriod relates to a date the rating is determined, and EndorsementPeriod to the date the endorsement was made. Equation (10) shows that an importance of an endorsement based on who made the endorsement and when. The older an endorsement, the lesser the importance or strength of the endorsement.

$${W}_{ic} = 1 - \frac{\vert Endorsed user by i in community c \vert}{\vert Users in community c \vert} \qquad ( 11 )$$

Equation (11) above is used to reduce importance of a mass endorsement or spam endorsement, for example an endorsement made by a teacher to all of the teacher's students. Consider an example of 10 students in a school. If 8 of the students receive an endorsement by the teacher W_{ic}=0.2. Using the example figures in Equation (11) above formula gives a result of 0.2=[1−(8/10)].

Equation (12) below provides an example of structured weighting.

$${W}_{m} = \{ \begin{matrix}1 & if i , j are not member of Same community \\ 0.8 & if i , j are member of Same community \\ 0.6 & if i , j are Friends or bidirectional Followers\end{matrix} \qquad ( 12 )$$

The values of Equation (12) are typically determined through experimentation, and can be refined and varied according to a subject of the ranking, e.g., student or institution, or other factors such as size of community and the like. The values of Equation (12) can be refined at time of analysis in some implementations. Using Equation (12), an endorsement provided a friend has less value or weighting than an endorsement provided by a member outside the community who is really interested in student's work. The weight Wₘ reduces the effect of endorsements by friends (mutual followers).

Equation (13) is used to determine whether an endorser is successful.

$$Successful ( u ) = \{ \begin{matrix}1 & if IsSuccessful ( u ) = True \\ 0.75 & else\end{matrix} \qquad ( 13 )$$

The values used in Equation (13) are typically determined by experimentation, and varied according to results of ongoing analysis. The values of Equation (13) can be refined at time of analysis in some implementations. To enhance the effect or strength of endorsements received from successful endorsers, a Successful metrics is defined. To determine the Successful metric, measures such as achieving a valuable position after graduation or winning any awards are considered.

Consistency of an endorsement is also considered using Equation (14).

$$Consistant ( u , {I}_{x} ) = 1 - \frac{1}{{( \vert Endorsement u recieved for {I}_{x} \vert )}^{2} + 1} \qquad ( 14 )$$

Equation (14) is used to check a consistency value of the received endorsement for a specific item with the previous endorsement. If a student or institution is endorsed for a first time by an endorser, the endorsement is typically assigned a predetermined weight of 0.5. In other implementations, the endorsement is initially assigned a value determined from experimentation and analysis of results.

A level of trust associated with an endorser providing an endorsement is determined using Equation (15).

$$Trust ( u ) = {W}_{T} \frac{{\sum }_{i}^{n} Trust ( i ) Where i is Friend with u}{n} + {W}_{V} VideoAutenetication ( u ) \qquad ( 15 )$$

Trust determined for user affects the strength of an endorsement made by a particular endorser. More trustable persons have higher endorsement strength. The measure of Trust in Equation (15) is determined based on two factors. Firstly, the average of trust of all other friends of current user is determined recursively. In other words, trust of an endorser is determined based in part on trust of those in the endorser's circle of friends. For example, each member of the circle of friends may be assigned a weight based upon the person's connections and history associated with virtual platform. Secondly, the trust measure is determined based on the video authentication value according to Equation (16) below.

$$VideoAuthentication ( u ) = \frac{\sum Reflection ( u )}{n} [ Where n is the number of questions ] \qquad ( 16 )$$

Determining the video authentication uses image and video processing techniques to identify facial expressions of an endorser in response to randomly presented questions (as described in relation to steps 225 and 230). Matching of the facial expression is implemented using known image recognition techniques such as machine learning methods or widely adopted software such as Microsoft™ Cognitive Services and the like. An average result relating to matching the facial expressions is determined in some implementations.

An average result relating to matching of different facial expressions affects the trust of user in our algorithm. For each endorser, a different set of questions is provided and videos recorded for trust analysis. The facial expressions of the responses are compared to a database of authentic facial expression to determine the authenticity and impact of the video endorsement on the rank.

In determining a social network feedback factor, UGC (User Generated Content) sentiment and topics are considered as factors. UGC (User Generated Content) is a summary of a number of posts, tweets, comments, and questions and answers generated by the virtual platform (whether for a student or institution). The social network feedback factor is determined by the ranking engine 415. In addition, facial expressions of endorsers in recorded videos are extracted with video analysis algorithms along with sentiment evaluation of the video's associated text. A number of joined groups likes and participated events are included in determining social network feedback factor. The social network feedback ranking metric can be applied for all Alumni, Social and Academic factors based on their requirements.

SocialNetFeedback=W_{xy1}CGC+W_{xy2}Video+W_{xy3}Likes+W_{zy4}Groups+W_{xy5}Events [Where ΣW_{xyi}=1] (17)

Equation (17) considers active (social media) time for each user. The active time is determined using Equation (18).

ActiveTimeᵢ=CurrentPeriod−RegistrationPeriod (18)

Factor which are otherwise difficult to quantise are taken into account using Equations (9) to (18) when determining ranking of an institution.

### Ranking Students

The arrangements described provide a method that uses academic, social and alumni data to determine a single score or ranking of a student in real time. In evaluating multiple students and ranking each of the students based on a single metric, an institution's (such as a university's) decision making criteria for selecting students is simplified.

FIG. 6 shows a method 600 of ranking students. The method 600 is typically implemented as one or more modules of the application 133, stored in the hard drive 110 and executed under control of the processor 105. The method 200 relates to using text and video endorsements from peers, competitors, experts and social network by recording, determining quantitative scores. The method 200 combines the scores with existing data sources and students' profiles to provide a comprehensive model for ranking students.

The method 600 starts at a receiving step 605. The server computer 101 operates to receive traditional, structured ranking information at step 605. The traditional ranking information is typically in numeric form and relates to academic results or training qualifications received from universities, schools, employers and the like. The ranking information is received from third party computer devices (not shown) in some implementations.

The method 600 receives data from both external an internal inputs. External inputs relate to external social media sources, such as external social media websites and applications (e.g., Facebook or Twitter and the like). External inputs can also relate to other types of websites, for example traditional ranking websites. External inputs can relate to text, video or other types of data.

Internal inputs relate to data received via a virtual plafform operated by the computing device 101 (as described in relation to step 625 below). Internal inputs received from the virtual platform can relate to text or video input or the like. Video inputs, whether internal or external inputs, can relate to spontaneous video (recorded live and received in near real-time) or non-spontaneous video (previously recorded). For ease of reference, inputs 351 to 356 of FIG. 3 represent both internal and external inputs.

Referring to FIG. 3, the method 600 receives data from example inputs 351 to 356. The responses are received and stored in the memory 109, for example in a temporary portion of the memory 109. The step 605 executes to receive structured data, such as data from inputs 354 to 356.

The method 600 progresses from the step 605 to an identifying step 610. At the step 610, the method 600 identifies unstructured data, typically social media data, relevant to the student. The social media data is derived using data provided to a virtual plafform implemented at step 625, as described hereafter. The social media data includes text and video data. The social media data can relate to both internal and external input data identified through the input from a social media database associated with the student. For example, the social media data can be derived from external social media accounts associated with the student (for example, Facebook, Twitter and the like), or social media data obtained from a virtual plafform operated by the computing device 101 at step 625. Social media data can be obtained or identified by known social media searching methods such as using hashtags and the like. Searching methods used at step 610 are similar to searching methods described in relation to step 210. The item extractor 325 executes to identify relevant data social media data from external inputs 351 to 354 for example.

The method 600 progresses from step 610 to an analysing step 615. At step 615, the application 133 executes to analyse a level of positive or negative sentiment present in written and video social endorsements. The step 615 operates in a similar manner to the step 215.

The method 600 progresses from step 615 to a categorising step 620. At step 620, the impact of the social media data is categorised. The impact of the identified social media is categorised in relation to recency, consistency, success of the endorser, relationship between endorser and endorsee, expertise, trust and other categories relating to the relationship between an endorser and an endorsee (person posting the social media and subject of the social media), as described in relation to Equations (11) to (16). The relationship between the endorser and the endorsee relates to one or more of number of endorsements (as per Equation (11)), commonality of community of an endorser or endorsee, (as described in relation to Equation (12)). The step 620 operates in a similar manner to step 220 of the method 200.

The method 600 progresses from the step 620 to an implementing step 625. At step 625, the method 600 implements a virtual platform in a similar manner to the step 225 of the method 200. The virtual platform records randomly generated questions and presents the questions to an endorser of the student, such as a high school teacher, careers advisor or coach of the student. For example, the questions are transmitted to a user or endorser device for display. The user provides spontaneous video responses in response to the randomly generated questions. The user responses are transmitted to the server computer 101. The responses received are considered genuine compared to responses to questions which endorsers have had time to rehearse. The method 600 accordingly inherently provides a degree of confidence in the endorsements received. The virtual platform is represented by an application 321, labelled “Student Net” in FIG. 3. The step 625 is configured to verify that a real person (rather than a computer) provides the endorsement in a similar manner to step 225 of the method 200.

The application 321 also operates to receive traditional social media data structures linked to user accounts. For example, virtual platform can receive text inputs such as posts, and other type of inputs such as image, audio and video files posted by users, and display the received information to appropriate user accounts.

The method 600 proceeds from the step 625 to a determining step 630. The application 133 determines a strength of each endorsement received at step 630. Step 630 effectively operates to determine whether the person provides a spontaneous or non-rehearsed endorsement. The strength of the endorsement relates to the authenticity of the endorsement. Step 630 operates to identify facial expressions received in video data of an endorser and analyse the identified facial expressions. The virtual platform of step 630 is implemented using known image recognition techniques such as machine learning methods or widely adopted software such as Microsoft™ Cognitive Services and the like. In other implementations, the application 133 executes to compare video responses received with a database of authentic facial expressions or by using software packages or machine learning methods (for example, algorithms for emotion detection which include techniques such as Bayesian networks, support vector machines (SVM) and decision trees to determine the strength of the endorsement for use in determining the rank of the institution. The step 630 operates in a similar manner to step 230 of the method 200. Appendix 1 represents pseudo-code for an endorsement algorithm.

The method 600 progresses under execution of the processor 105 from step 630 to a generating step 635. The step 635 executes to generate an output rank. The output rank is generated based on the rank information of step 205, the determined sentiment and categorisation of the social media (steps 615 and 620), and the determined strength of the endorsement data (step 630). Referring to FIG. 3, the ranking engine 360 generates the rank of the student.

The steps of the method 600 are implemented in an example order in FIG. 6. In other arrangements, some of the steps of the method 600 may be executed concurrently. The method 600 operates to update in real-time when a new endorsement is received, or new social media data is received. If a certain type of data is not received, for example data from asocial media, the method 600 can execute nonetheless.

In one arrangement, the step 635 executes to determine ranking of the student, based upon Equation (19)

StudentRankingᵢ=f(AcademicPerformanceᵢ, Leadershipᵢ, SchoolRankingᵢ) (19)

Equation (19) is normally implemented using similar arrangements to Equation (1). The subject of the ranking is a student. Weights are assigned according to importance of factors of the function of Equation (20). Summation of the weights should total 1. Metrics, also referred to as factors (AcademicPerformance, Leadership and SchoolRanking), used in Equation (19) are evaluated through sub-metrics and from different resources described above. The metrics are converted into numerical and normalized values with similar scales.

StudentRanking_{y}=W₁AcademicPerformance_{y}+W₂Leadership_{y}+W₃SchoolRanking_{y}[Where ΣWᵢ=1] (20)

The factor AcademicPerformance is broken down into a new weighted list of sub-factors, as per Equations (21) and (22).

AcademicPerformance_{y}=W₁₁NormalizedAcademicRecord_{y}+W₁₂AcademicHonours_{y}+W₁₃SocialNetFeedback_{y}+W₁₄EndorseValue_{y}[Where ΣW₁ᵢ=1] (21)

AcademicPerformance=F2(NormalizedAcademicRecord, AcademicHonours,SocialNetFeedback, Endorse Value) (22)

Similarly, a hierarchy is determined for the other factors, for example using Equations (23) to (26) below.

$$\begin{matrix}{SchoolRanking}_{x} = {W}_{41} {NormalizedSchoolRanking}_{x} + {W}_{42} {Alumni}_{x} [ Where \sum {W}_{4 i} = 1 ] & ( 23 ) \\ SchoolRanking = F 5 ( NormalizedSchoolRanking , Alumni ) & ( 24 ) \\ {Leadership}_{x} = {W}_{51} {SocialNetFeedback}_{x} + {W}_{52} {EndorseValue}_{x} + {W}_{53} {ActiveTime}_{x} [ Where \sum {W}_{5 i} = 1 ] & ( 25 ) \\ Leadership = F 6 ( SocialNetFeedback , EndorseValue , ActiveTime ) & ( 26 )\end{matrix}$$

All the above-mentioned factors are a general model for ranking students. Similarly to Equations (1) to (8), Equations (19) to (26) provide a relatively flexible solution that can be manipulated in terms structure and weight values without undue difficulty. Another arrangement considers the social network endorsement by other students using Equations (9) to (18). The generated ranking accounts for an effect of recency of endorsement, reputation of the endorser, and trust or strength determined for the endorsement.

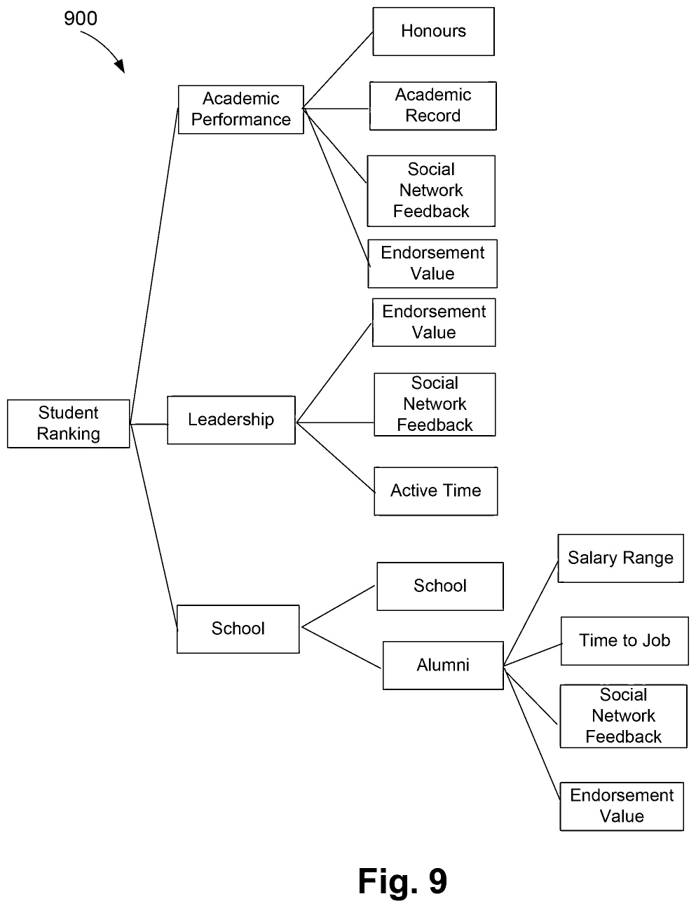

FIG. 9 shows an example of a tree structure 900 of factors and associated sub-factors considered in determining rank of a student.

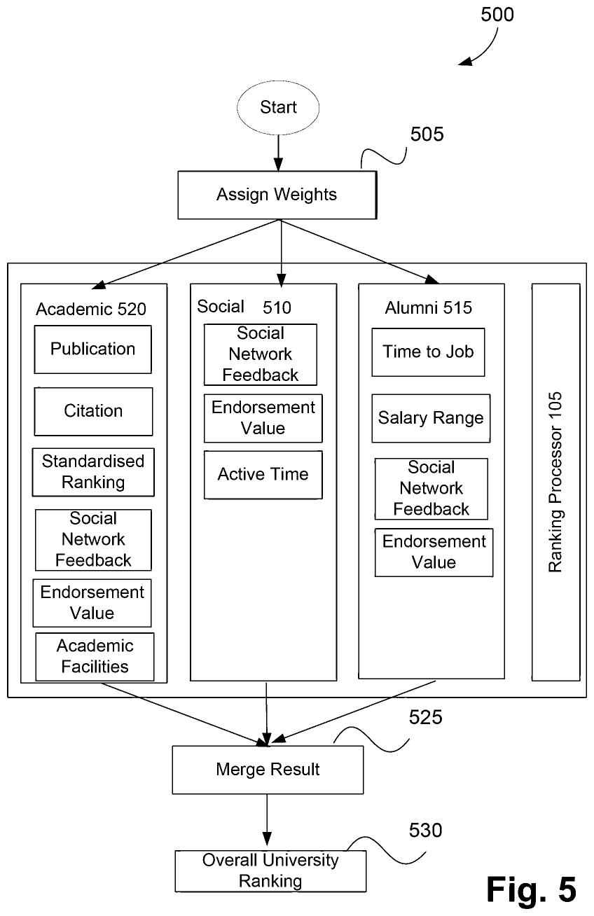

FIG. 5 shows a data flow 500 implemented at step 235 of the method 200. The dataflow 500 starts by assigning weights 505. Each of a set of weighted factors Social (510), Alumni (515) and Academic (520) are divided into weighted sub-factors. The weighted factors 510, 515 and 520 are merged into a result 525 which is output as a single numerical result 530.

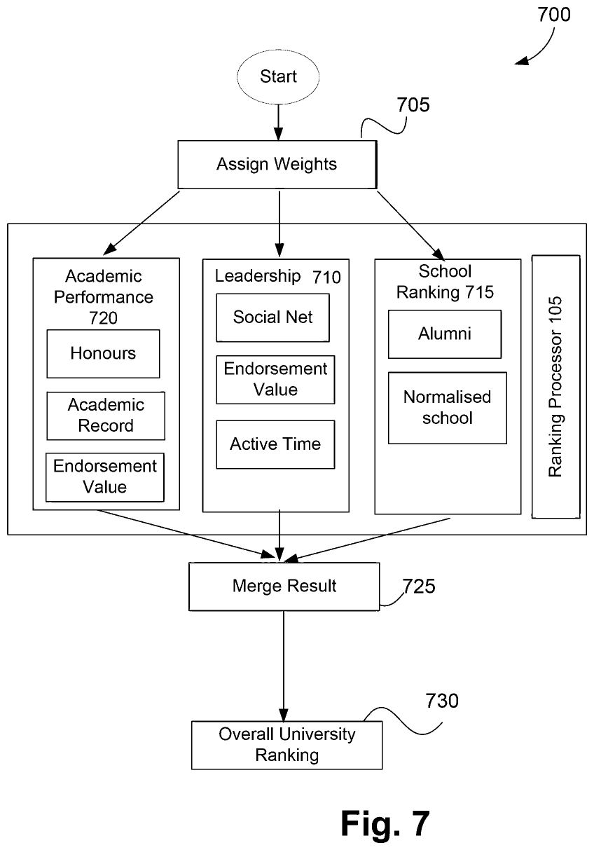

FIG. 7 shows a dataflow 700 implemented at step 635 of the method 600. The dataflow 700 starts by assigning weights 705. Each of a set of weighted factors Leadership (710), School Ranking (715) and Academic Performance (720) are divided into weighted sub-factors. The weighted factors 710, 715 and 720 are merged into a result 725 which is output as a single numerical result 730.

The ranking methods described above are weighted to consider academic, social, and alumni metrics as main contributors to ranking of an institution, and leadership, school ranking and academic performance metrics as main contributors to ranking of a student. The methods described provide a flexible approach for both ranking students and universities, and provide a mechanism to apply endorsements value based on consistency with previous endorsements.

The factors considered and quantified in the methods for determining ranking of a student or university are compared with existing ranking approached in Tables 1 and 2 below.

TABLE 1
Comparisons of proposed
University ranking with current ranking approaches

| | Times Higher | QS | | |
|---|---|---|---|---|
| | Education | Ranking | Shanghai | Proposed |
| Academic | | | | |
| Citations | √ | √ | √ | √ |
| Publications | √ | √ | √ | √ |
| Social Network | | | | √ |
| Academic activities | | | | |
| Standard University | | | | √ |
| Rankings | | | | |
| Endorsement Value | | | | √ |
| Facilities | √ | √ | √ | √ |
| Alumni | | | | |
| Time to find a job | | | | √ |
| Salary Range | √ | √ | | √ |
| Alumni's Social | | | | √ |
| Network activities | | | | |
| Endorsement Value | | | | √ |
| Social | | | | |
| Endorsement Value | | | | √ |
| Active Time | | | | √ |
| Trust Evaluation | | | | √ |
| Social Network | | | | √ |
| activities | | | | |

TABLE 2
Comparisons of current student ranking with proposed technique

| | Current | Proposed |
|---|---|---|
| Integrated | | √ |
| Academic Records | √ | √ |
| Honours | √ | √ |
| Endorsement | | √ |
| Social network activities | | √ |
| Trust Evaluation | | √ |
| Visual Authentication | | √ |
| Automated computerised | | √ |

Along with all above-mentioned factors the methods for ranking both universities and students differ in flexibility with existing models and techniques. Table 3 illustrates the differences.

TABLE 3
General Methodical Differences of current and proposed rankings

| | Current | Proposed |
|---|---|---|
| Real-Time Processing | | √ |
| Sentiment Analysis | | √ |
| Strength (Authenticity) of Endorsements | | √ |
| Spontaneous Video Authentication | | √ |

The arrangements described provide a means of quantifying unstructured data such as social media. The trustworthiness or weight which should be applied to social media is determined to prevent unsuitable or untrustworthy endorsements or posts from having an overly influential effect on the overall ranking.

### Industrial Applicability

The arrangements described are applicable to the computer and data processing industries and particularly for the education ranking industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

### Appendix 1

### Algorithms

Algorithm 1, represents pseudo-code for an Endorsement Algorithm. Algorithm 1 focuses on students, universities, schools, and teachers/lectures who can endorse someone from their types or other types. For example, a lecturer may endorse a student for math also another student may endorse this student for math.

Algorithm 1: Endorsement Algorithm

```
Input: List of Students Stds, List of Universities Unis, List of Schools
Schs, List of Teachers Tchs, List of Endorsement Items Ends
Output: Cube of End [x,y,z]
Process:
ListMerged.Add(1,Stds)
ListMerged.Add(2,Unis)
ListMerged.Add(3,Schs)
ListMerged.Add(4,Tchs)
Ends.Sort( )
For i=1 to 4
{
  For j=1 to 4
  {
    For each x in ListMerged[i ]
    {
      For each y in ListMerged[j]
      {
        For each z in Ends
        {
          End[x,y,z]=EndorseValue(x,y,z);
        }
      }
  }
}
```

For the other metrics such as citations and publications, sources like Google Scholar™ can be used to gather data for academic staff of universities. The following algorithms represent the high-level demonstration of citation and publication for universities

Algorithm 2: Citation & Publication

```
Input: List of Universities Unis, List of Universities’ Staff
Output: List of Universities Publication and Citations (Pubs & Cits)
Process:
For i=1 to Unis.count( )
{
  C=0
  P=0
  For j=1 to Unis[i].staffs.count( )
  {
    S= Unis[i].staffs[j]
    C=RetreivePublication(s)+C
    P=RetrieveCitation(s)+P
  }
  Pubs.add(Unis[i],P)
  Cits.add(Unis[i],C)
}
```

### Appendix 2

### General Ranking Factors

TABLE 4
General factors normally used by university rankings

| Criteria | Indicator |
|---|---|
| Research | Amount of received grants |
| | Number of patents, papers, books |
| | Number of commercialised products |
| | Number of Postdocs |
| Infrastructure | Equipment |
| | Facilities |
| Teaching | Ratio of Students/Staff (Academic, Administrative) |
| | Number of programmes |
| Human Resource | Number of Staff with PhD |
| | Peer review results |
| Consultancy | Consultancy income |
| Internationalization | Number of International Academic Staff |
| | Number of International Students |
| Students | GPA of admitted students to university |
| | programmes |
| | Ratio of employed graduates |
| | Alumni's awards |
| | Number of Ph.D. students |
| Service Delivery | Customer satisfaction |

1. A method of determining rank of an institution, comprising:
receiving rank information relating to academic performance of the institution;
identifying social media data associated with the institution, the social media data comprising text and video data;
analysing sentiment associated with the social media data, the analysis including categorising relevance of the social media data;
receiving endorsement data;
determining strength of the endorsement data; and
generating an output rank of the institution, the output rank being generated based on the rank information, the determined relevance of the social media, and the determined strength of the endorsement data.

2. A method of determining rank of a student, comprising:
receiving information relating to academic performance of the student;
identifying social media data associated with the student, the social media data comprising text and video data;
analysing sentiment associated with the social media data, the analysis including categorising relevance of the social media data;
receiving endorsement data;
determining strength of the endorsement data; and
generating an output rank of the student, the output rank being generated based on the academic performance of the student, the determined relevance of the social media, and the determined strength of the endorsement data.

3. The method according to claim 1, wherein receiving endorsement data comprises transmitting a number of questions to an endorser device receiving video data.

4. The method according to claim 3, wherein the number of questions are randomly selected from a database of questions.

5. The method according to claim 1, wherein the endorsement data comprises video data and determining strength of the endorsement data comprises analysing facial expressions of endorsers in the video data.

6. The method according to claim 1, further comprising determining a level of trust associated with the endorsement data.

7. The method according to claim 1, wherein the strength of the endorsement data relates to authenticity of the endorsement data.

8. The method according to claim 2, further comprising verifying that the endorsement data is received from a real person.

9. A non-transitory computer readable storage medium having a computer program stored thereon for determining rank of an institution, the computer program comprising:
code for receiving rank information relating to academic performance of the institution; code for identifying social media data associated with the institution, the social media data comprising text and video data;
code for analysing sentiment associated with the social media data, the analysis including categorising relevance of the social media data;
code for receiving endorsement data;
code for determining strength of the endorsement data; and
code for generating an output rank of the institution, the output rank being generated based on the rank information, the determined relevance of the social media, and the determined strength of the endorsement data.

10. A non-transitory computer readable storage medium having a computer program stored thereon for determining rank of a student, the computer program comprising:
code for receiving information relating to academic performance of the student;
code for identifying social media data associated with the student, the social media data comprising text and video data;
code for analysing sentiment associated with the social media data, the analysis including categorising relevance of the social media data;
code for receiving endorsement data;
code for determining strength of the endorsement data; and
code for generating an output rank of the student, the output rank being generated based on the academic performance of the student, the determined relevance of the social media, and the determined strength of the endorsement data.

11. A system, comprising:
a memory for storing data and a computer readable medium; and
a processor coupled to the memory for executing a computer program, the program having instructions for:
receiving rank information relating to academic performance of an institution; identifying social media data associated with the institution, the social media data comprising text and video data;
analysing sentiment associated with the social media data, the analysis including categorising relevance of the social media data;
receiving endorsement data;
determining strength of the endorsement data; and
generating an output rank of the institution, the output rank being generated based on the rank information, the determined relevance of the social media, and the determined strength of the endorsement data.

12. A system, comprising:
a memory for storing data and a computer readable medium; and
a processor coupled to the memory for executing a computer program, the program having instructions for:
receiving information relating to academic performance of a student;
identifying social media data associated with the student, the social media data comprising text and video data;
analysing sentiment associated with the social media data, the analysis including categorising relevance of the social media data;
receiving endorsement data;
determining strength of the endorsement data; and
generating an output rank of the student, the output rank being generated based on the academic performance of the student, the determined relevance of the social media, and the determined strength of the endorsement data.
